(19) United States
(12) Patent Application Publication
(10) Pub. No.: US 2023/0218961 A1
(43) Pub. Date: Jul. 13, 2023

(54) Method and Apparatus for Racket Customization

(71) Applicant: Elding Ind. Co., Ltd., Taichung City (TW)

(72) Inventor: Suer Huang, Taichung City (TW)

(21) Appl. No.: 17/737,651

(22) Filed: May 5, 2022

(30) Foreign Application Priority Data
Jan. 12, 2022 (TW) 111101239

(51) Int. Cl. A63B 60/42; G06F 3/0488

(52) U.S. Cl. CPC A63B 60/42; G06F 3/0488

(57) ABSTRACT

A method for racket customization includes the steps of measuring data of a total length, a racket head length, a net weight, a swing weight and a balance spot of a racket; using a calculation unit to integrate the data. When a user customizes the data of one of the net weight, the swing weight and the balance spot, a position where an additional weight is to be put on the racket can be calculated. In this way, the user can customize the desired racket easily and quickly.

### CROSS-REFERENCE TO RELATED APPLICATIONS

This application is based upon and claims priority under 35 U.S.C. 119 from Taiwan Patent Application No. 111101239 filed on Jan. 12, 2022, which is hereby specifically incorporated herein by this reference thereto.

### FIELD OF THE INVENTION

The present invention relates to a racket, and more particularly to a method and an apparatus for modifying a racket according to custom conditions.

### BACKGROUND OF THE INVENTION

There are many sports that hit a ball by swinging a racket, such as tennis, badminton, squash, and so on. Some sports are widely loved and concerned. In addition to recreational activities, professional leagues have been developed. Therefore, the sports science related to these sports has caused extensive research.

The user may modify the racket according to his/her habit to grasp the racket handle and the hand feeling of swinging the racket, so that the user can hit the ball smoothly, that is, the user hopes that the racket can be customized. The common way of customizing a racket is to attach lead tape on the racket, thereby increasing the weight of the racket to change the hand feeling. However, the position where the lead tape is attached to the racket will change the swing weight of the racket, which is an important parameter that affects the user's hand feeling of swinging the racket. Or, the user wants to change the swing weight but has no idea how much to add the additional weight and where the additional weight is to be put on the racket. The general public, even professional athletes, don't do research on how to swing the racket and hit the ball effectively. Most of them rely on their own feelings. Therefore, the user tries to attach the lead tape to one position of the racket temporarily and then actually swings the racket to test the hand feeling, or uses an instrument to measure the swing weight for testing the hand feeling. If the sway weight won't satisfy the user, the lead tap is attached to another position of the racket, and the test is repeated until the sway weight satisfies the user.

However, this trial and error method takes too much time, and may not find the best position for attaching the lead tape to the racket because there is no objective standard. In view of this, the inventor of the present invention has devoted himself based on his many years of practical experiences to solve these problems.

### SUMMARY OF THE INVENTION

The primary object of the present invention is to provide a method and an apparatus for racket customization, which can automatically calculate an additional weight to be added on a racket and the position of the additional weight to be put on the racket in a short time, so as to customize the user's racket quickly and accurately.

Another object of the present invention is to provide an apparatus for racket customization, which comprises a measurement unit, a calculation unit and an operation display unit to allow users to customize the racket on a machine with ease according to their needs.

In order to achieve the objects, a method for racket customization provided by the present invention comprises the steps of: measuring data of a net weight, a swing weight and a balance spot of a racket; measuring data of a total length of the racket and a racket head length; using a calculation unit to integrate the data of the total length, the racket head length, the net weight, the swing weight and the balance spot; wherein when a user customizes the data of one of the net weight, the swing weight and the balance spot, a position where an additional weight is to be put on the racket can be calculated; or when the user changes the position of the additional weight on the racket, the data of the net weight, the swing weight and the balance spot of the racket can be calculated in real time.

In order to achieve the objects, an apparatus for racket customization provided by the present invention comprises a machine having a measurement unit, a calculation unit and an operation display unit.

The measurement unit includes a holding seat, a first bracket and a second bracket that are disposed on the machine. The holding seat is configured for a racket handle bottom end of a racket to abut against the holding seat. A first distance is defined between the first bracket and the holding seat. A second distance is defined between the second bracket and the first bracket. The first bracket is connected to a first weighing unit. The second bracket is connected to a second weighing unit. A swing weight sensor is disposed on the machine.

The operation display unit is disposed on a surface of the machine for displaying the data of the net weight, the swing weight and the balance spot of the racket measured by the measurement unit. The operation display unit is operable for a user to input custom data.

The calculation unit is disposed inside the machine. The calculation unit is electrically connected to the measurement unit and the operation display unit for integrating the measured data of the net weight, the swing weight and the balance spot of the racket as well as the input data of the total length of the racket and the racket head length of the racket to be calculated and displayed on the operation display unit.

### BRIEF DESCRIPTION OF THE DRAWINGS

FIG. 1 is a perspective view of the apparatus of the present invention;

FIG. 2 is a schematic view of the apparatus of the present invention when in use; and

FIGS. 3-7 are schematic views showing the operation interface of the apparatus of the present invention.

### DETAILED DESCRIPTION OF THE PREFERRED EMBODIMENTS

A method for racket customization provided by the present invention comprises the steps of:

measuring data of a total length of a racket and a racket head length; measuring data of a net weight, a swing weight and a balance spot of the racket; using a calculation unit to integrate the data of the total length, the racket head length, the net weight, the swing weight and the balance spot; wherein when a user customizes the data of one of the net weight, the swing weight and the balance spot, an additional weight that the racket needs to change or a position where the additional weight is to be put on the racket can be calculated; or when the user changes the position of the additional weight on the racket, the data of the net weight, the swing weight and the balance spot of the racket can be calculated in real time, so that the user can determine the position of the additional weight according to the data.

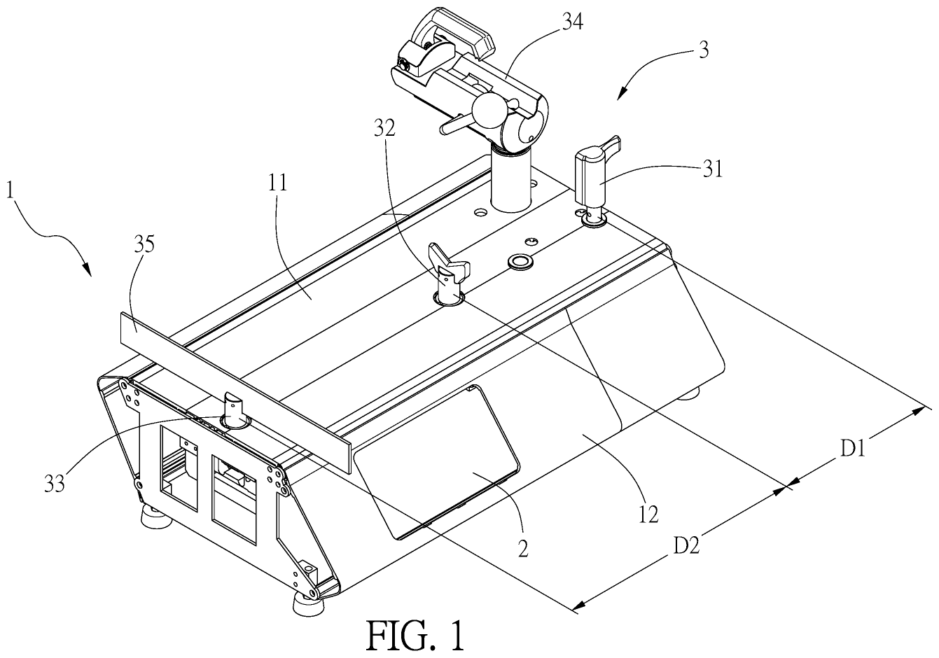

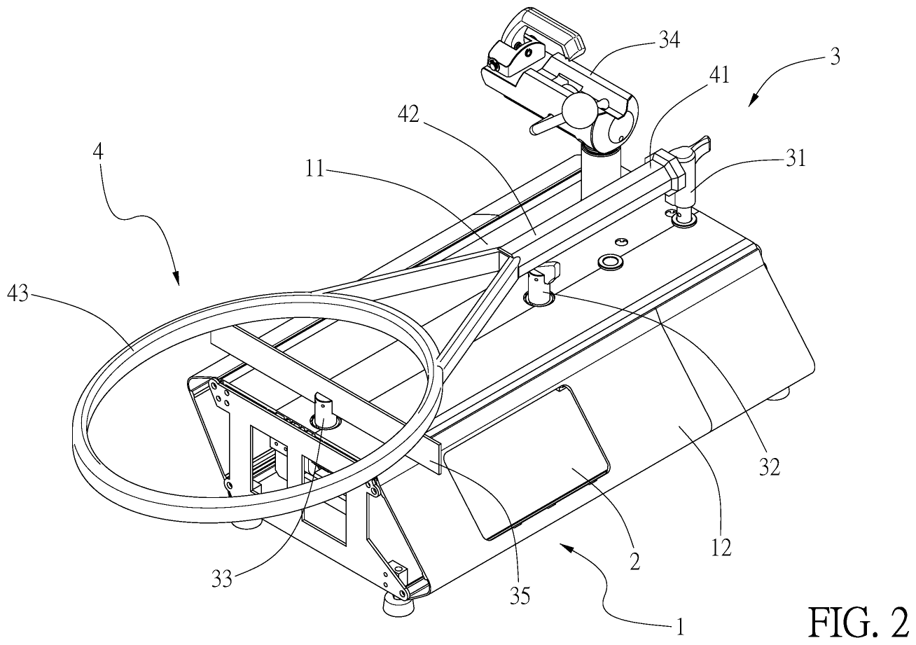

The above method can be carried out by the apparatus of the present invention as shown in FIG. 1 and FIG. 2. As shown in the figures, the apparatus for racket customization of the present invention comprises a machine 1, a measurement unit 3, an operation display unit 2, and a calculation unit (not shown) inside the machine 1. The calculation unit is electrically connected to the measurement unit 3 and the operation display unit 2.

The machine 1 has a flat top surface 11 and a front side surface 12. The measurement unit 3 includes a swing weight sensor 34 disposed on the top surface 11 for measuring the swing weight of the racket, a holding seat 31, a first bracket 32, and a second bracket 33. As shown in FIG. 2, the holding seat 31 is configured for a racket handle bottom end 41 of the racket 4 to abut against the holding seat 31, so as to locate and demarcate the position of the racket 4. The first bracket 32 is configured to hold a racket handle top end 42. The second bracket 33 includes a lateral holder 35 for holding a racket head 43. A first distance D1 is defined between the first bracket 32 and the holding seat 31. A second distance D2 is defined between the second bracket 33 and the first bracket 32. The first and second distances are known fixed values. The underside of the first bracket 32 is connected to a first weighing unit (not shown in the figures). The underside of the second bracket 33 is connected to a second weighing unit (not shown in the figures). When the racket 4 is placed on the machine 1 and positioned on the holding seat 31, the first bracket 32 and the second bracket 33 as shown in FIG. 2, the data of the net weight of the racket 4 is measured by the first weighing unit and the second weighing unit, and the data of the balance spot of the racket 4 is calculated by the calculation unit in cooperation with the information of the first distance D1 and the second distance D2.

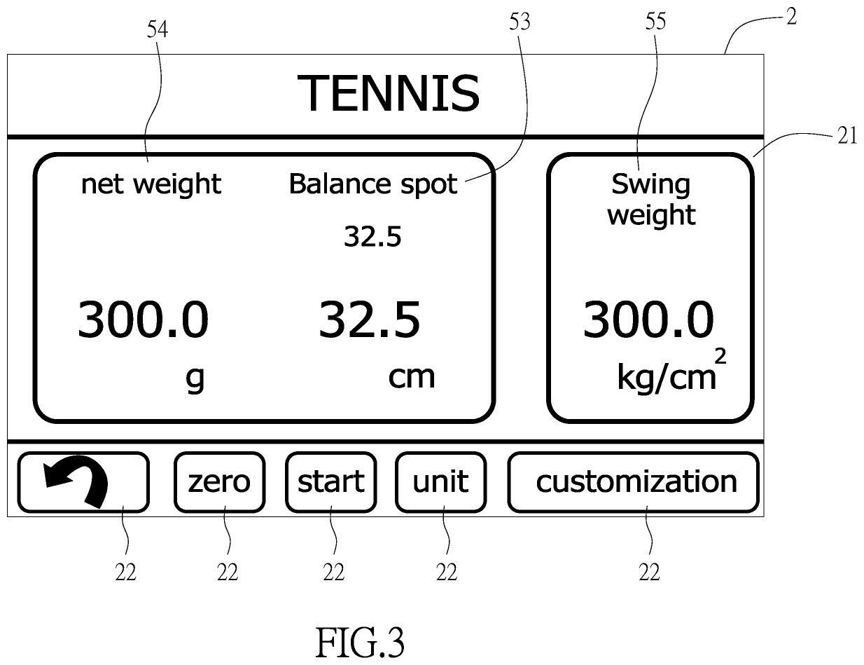

The operation display unit 2 is disposed on the front side surface 12 for displaying the measured data of the net weight, the swing weight and the balance spot of the racket (referring to FIG. 3). In this embodiment, the operation display unit 2 is a touch screen. The touch screen has a display area 21 for displaying information and a plurality of operation buttons 22 that can be directly clicked to input commands or information.

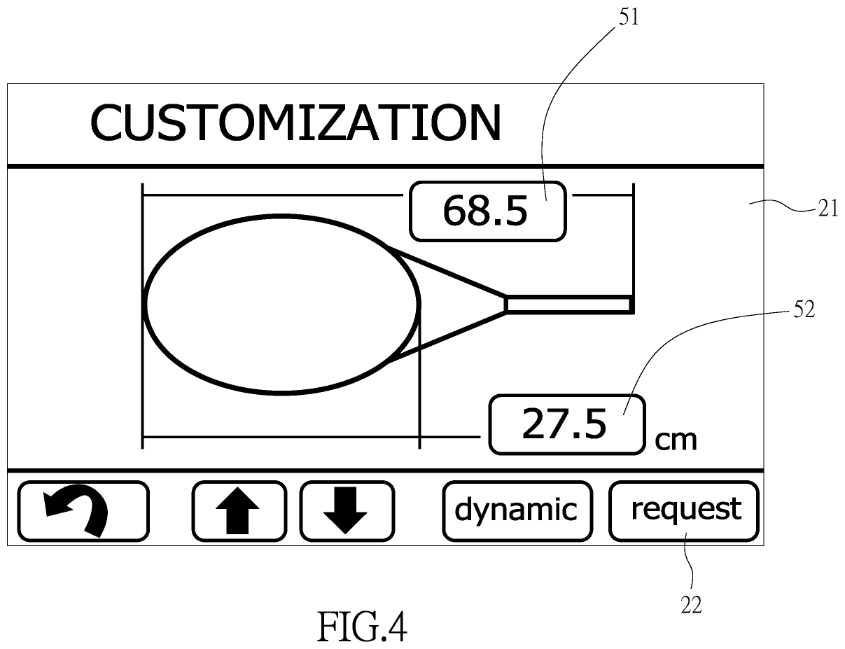

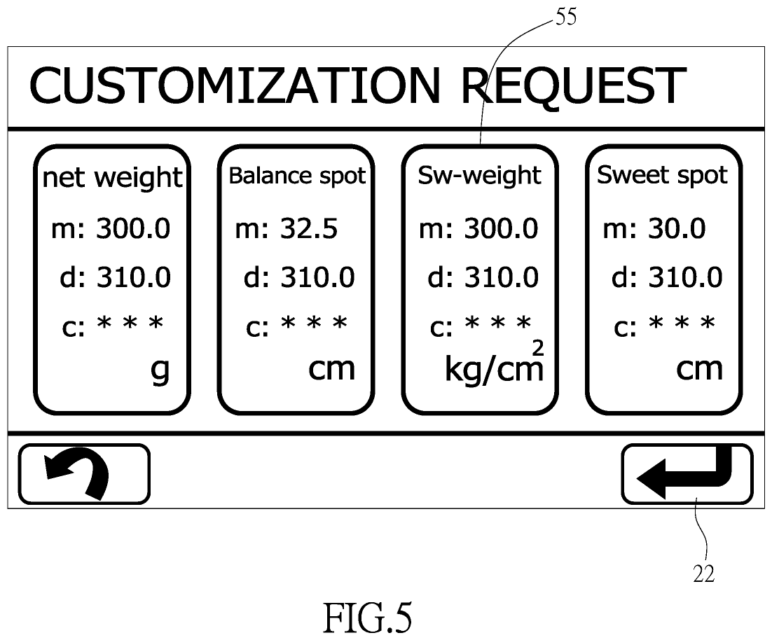

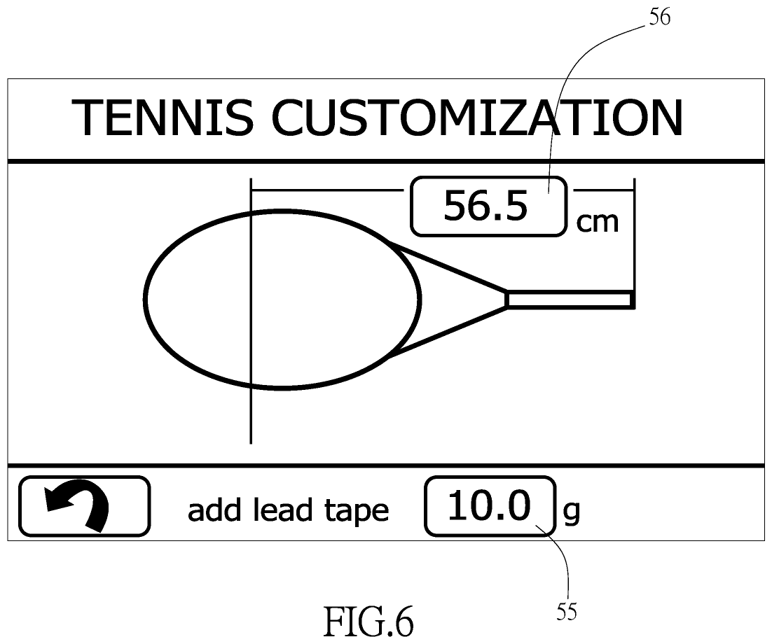

As shown in FIGS. 2-7, in actual operation, when the user wants to customize the swing weight of a racket, the data of the swing weight of the racket 4 is measured by the swing weight sensor 34. After that, the racket 4 is placed on the first bracket 32 and the second bracket 33, and the racket handle bottom end 41 abuts against the holding seat 31. At this time, after the calculation by the calculation unit, the data of the net weight 54, the swing weight 55 and the balance spot 53 of the racket 4 is displayed on the operation display unit 2 (as shown in FIG. 3). After inputting data of a total length 51 of the racket 4 and a racket head length 52 (as shown in FIG. 4), the operation button 22 with the custom function is pressed and operated to adjust the data of the swing weight 55 (as shown in FIG. 5). The swing weight 55 is adjusted to the data to be customized. When the operation button 22 with the confirmation function is pressed, the calculation unit automatically calculates the data and the operation display unit 2 displays an additional weight 57 that needs to be increased and a position 56 of the additional weight put on the racket 4, so that the purpose of racket customization can be achieved easily and quickly.

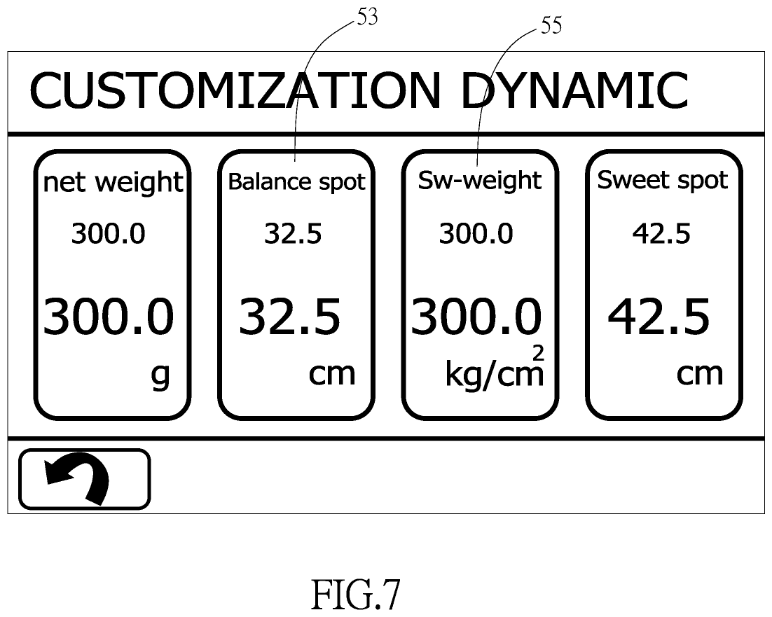

Furthermore, the present invention provides another operation mode which is different from the previous operation mode. The user can dynamically adjust the conditions to be customized. For example, the user is aware of the data of the desired swing weight or the balance spot, the weight of the racket is to be increased without changing the data. The operation is the same as the previous paragraph. After inputting the data of the total length 51 of the racket 4 and the racket head length 52, the operation button 22 with the dynamic function is pressed. The operation display unit 2 displays the data of the net weight 54, the swing weight 55 and the balance spot 53 of the racket 4 (as shown in FIG. 7) in real time. The user puts the additional weight on the racket and determines the position of the additional weight to be put on the racket according to the change of the data of the swing weight 55 or the balance spot 53 displayed on the operation display unit 2. Similarly, the purpose of racket customization can be achieved easily and quickly.

With the above structure, even if the user does not know much about the motion principle of swinging the racket to hit a ball, he/she can adjust and modify the racket quickly, without trial and error. For example, the user feels that a certain old racket can be swung smoothly, and the swing weight of the old racket is 310 kg-cm2 after testing. If the user wants to modify a new racket to have the same hand feeling as the old racket, the new racket is placed on the apparatus of the present invention. Then, the user inputs information, such as the total length of the racket, the racket head length, the weight of lead tape to be added and the desired swing weight value, through the operation display unit. The calculation unit automatically calculates the position where the lead tape is to be attached to the racket and displays it on the operation display unit. The user attaches the lead tape to the position according to the instructions, and the new racket has the same hand feeling as the old racket. The whole process can be completed quickly and is time-saving.

The method and the apparatus for racket customization provided by the present invention can be applied to tennis rackets, badminton rackets, squash rackets, American squash rackets, pickleball rackets and paddle tennis rackets, using different algorithms to achieve automatic calculation and provide instructions.

What is claimed is:

1. A method for racket customization, comprising the steps of:
measuring data of a net weight, a swing weight and a balance spot of a racket;
measuring data of a total length of the racket and a racket head length;
using a calculation unit to integrate the data of the total length, the racket head length, the net weight, the swing weight and the balance spot; wherein when a user customizes the data of one of the net weight, the swing weight and the balance spot, an additional weight that the racket needs to change or a position where the additional weight is to be put on the racket can be calculated.

2. A method for racket customization, comprising the steps of:
measuring data of a net weight, a swing weight and a balance spot of a racket;
measuring data of a total length of the racket and a racket head length;
using a calculation unit to integrate the data of the total length, the racket head length, the net weight, the swing weight and the balance spot; wherein when a user changes a position of an additional weight on the racket, the data of the net weight, the swing weight and the balance spot of the racket can be calculated in real time, so that the user can determine the position of the additional weight according to the data.

3. An apparatus for racket customization, comprising:
a measurement unit, configured to measure data of a net weight, a swing weight and a balance spot of a racket;
a calculation unit, configured to receive the data of the net weight, the swing weight and the balance spot of the racket as well as data of a total length of the racket and a racket head length of the racket and calculate the data of the net weight, the swing weight and the balance spot of the racket in real time;
an operation display unit, configured to display the data of the net weight, the swing weight and the balance spot of the racket in real time measured by the measurement unit and calculated by the calculation unit, the operation display unit being operable to change the data of the net weight, the swing weight and the balance point.

4. The apparatus as claimed in claim 3, further comprising a machine having the measurement unit, the calculation unit and the operation display unit;
the measurement unit including a holding seat, a first bracket and a second bracket that are disposed on the machine, the holding seat being configured for a racket handle bottom end of the racket to abut against the holding seat, a first distance being defined between the first bracket and the holding seat, a second distance being defined between the second bracket and the first bracket, wherein the first bracket is connected to a first weighing unit, the second bracket is connected to a second weighing unit, and a swing weight sensor is disposed on the machine;
the operation display unit being disposed on a surface of the machine for displaying the data of the net weight, the swing weight and the balance spot of the racket measured by the measurement unit, the operation display unit being operable for a user to input custom data;
the calculation unit being disposed inside the machine, the calculation unit being electrically connected to the measurement unit and the operation display unit for integrating the measured data of the net weight, the swing weight and the balance spot of the racket as well as the input data of the total length of the racket and the racket head length of the racket to be calculated and displayed on the operation display unit.

5. The apparatus as claimed in claim 4, wherein the operation display unit is a touch screen, and the touch screen has a display area and a plurality of operation buttons.
